(19) United States
(12) Patent Application Publication
(10) Pub. No.: US 2016/0071439 A1
(43) Pub. Date: Mar. 10, 2016

(54) Spring Arm Gift Card Holder

(71) Applicant: American Greetings Corporation, Cleveland, OH (US)

(72) Inventors: Katalina Speck, Rocky River, OH (US); Sarah Mason, Westlake, OH (US)

(21) Appl. No.: 14/942,571

(22) Filed: Nov. 16, 2015

Related U.S. Application Data
(63) Continuation-in-part of application No. 14/664,996, filed on Mar. 23, 2015.
Application No. 14/664,996 is a continuation-in-part of application No. 13/447,458, filed on Apr. 16, 2012, now abandoned.
Application No. 13/447,458 is a continuation-in-part of application No. 12/940,145, filed on Nov. 5, 2010, now Pat. No. 8,230,624.
Application No. 14/664,996 is a continuation-in-part of application No. 14/228,757, filed on Mar. 28, 2014.
Application No. 14/228,757 is a continuation-in-part of application No. 13/873,033, filed on Apr. 29, 2013, now Pat. No. 8,857,082.
Application No. 13/873,033 is a continuation-in-part of application No. 13/743,806, filed on Jan. 17, 2013, now Pat. No. 8,490,306.
Application No. 13/743,806 is a continuation-in-part of application No. 13/447,403, filed on Apr. 16, 2012, now Pat. No. 9,009,998.
Application No. 13/447,403 is a continuation-in-part of application No. 12/940,145, filed on Nov. 5, 2010, now Pat. No. 8,230,624.
Application No. 14/664,996 is a continuation-in-part of application No. 14/535,129, filed on Nov. 6, 2014.
(60) Provisional application No. 61/286,184, filed on Dec. 14, 2009.
(60) Provisional application No. 61/286,184, filed on Dec. 14, 2009.
(60) Provisional application No. 61/902,496, filed on Nov. 11, 2013.

(51) Int. Cl. G09F 1/10; F16M 11/04; F16M 11/40

(52) U.S. Cl. CPC G09F 1/10; F16M 11/40; F16M 11/041

(57) ABSTRACT

The gift card holder of the present invention is a device for holding a gift card within a box or other packaging that allows the gift card to move between horizontal and vertical positions with the opening and closing of the box or packaging.

### RELATED APPLICATIONS

This patent application is a continuation-in-part of and claims priority to U.S. patent application Ser. No. 14/664,996, filed on Mar. 23, 2015, a copy of which is incorporated herein by reference in its entirety.

### FIELD OF THE INVENTION

The present invention is in the field of social expression products and more specifically to gift card holders.

### SUMMARY OF THE INVENTION

The spring arm gift card holder of the present invention is a device for holding a gift card within a box or other packaging that allows the gift card to move between horizontal and vertical positions with the opening and closing of the box or packaging.

### DESCRIPTION OF THE DRAWINGS

FIG. 1 is a perspective view of the spring arm gift card holder of the present invention, as part of a gift card holder (box).

FIG. 2 is a profile view of the spring arm gift card holder of FIG. 1.

FIG. 3 is a perspective tear away view of the spring arm gift card holder of FIG. 1.

FIG. 4 is a perspective view of the box of FIG. 1, in a closed position.

FIG. 5 is a profile view of the spring arm gift card holder of FIG. 4 from the perspective of arrows 5-5.

### DETAILED DESCRIPTION OF PREFERRED AND ALTERNATE EMBODIMENTS

The present invention is directed to a gift card holder which includes a coiled spring with a channel attached to one end thereof, the channel being operative to releasably hold a gift card therein. The term “gift card” is used to refer to a stored value card, a transaction card, and in addition to gift cards-type payment devices, the channel can alternatively be used to hold a credit card, a stored value card, a greeting card, a note card, a post card, a picture, money, a receipt, or any other substantially thin (enough to fit within the opposing walls of the channel) and planar gift item. The gift card (or other item) may also be contained within a thin sleeve or envelope. Therefore, the term “gift card” is used herein to refer to any one of these items which can be placed into the spring arm channel that is described herein.

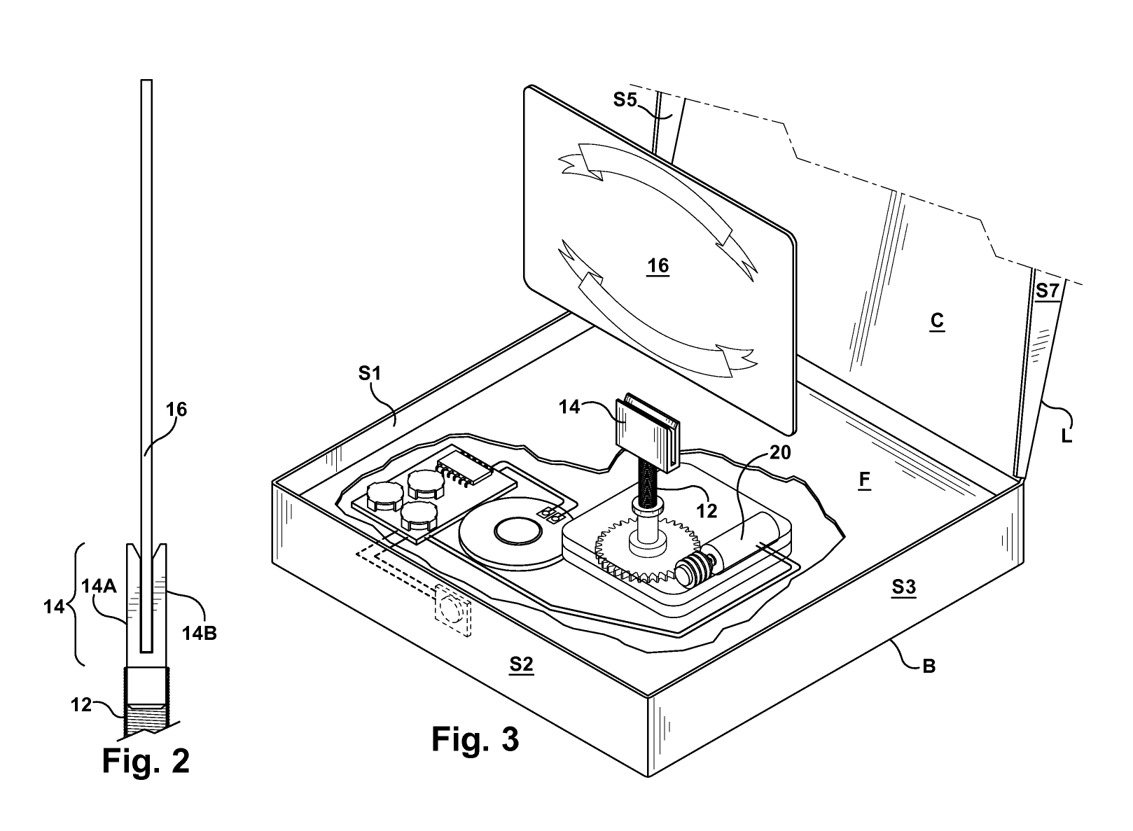

The base of the spring arm gift card holder GCH includes a coiled or helical spring 12. The spring 12 is made of an elastic material formed into a shape of a helix which returns to its natural length when unloaded. In a preferred embodiment, the spring 12 is made of metal but can be made of any other elastic material. At one end of the spring 12 is attached a channel 14. In profile, the channel 14 is u-shaped with two opposing sides 14A, 14B and a bottom 14C attaching the two opposing sides 14A, 14B. In a preferred embodiment, the two opposing sides 14A, 14B of the channel 14 are substantially rectangular, however, they can be formed into other shapes, such as a square, a circle, a triangle, or any other conceivable shape (linear or non-linear). The width of the channel 14 is such that it is able to securely hold or frictionally engage a standard sized gift card 16 therein without the need for additional retaining mechanisms. The overall size of the channel 14 is such that it holds only a portion of the gift card 16 herein so a significant portion of the front and rear surfaces of the gift card 16 are still visible. The widthwise edges of the gift card 16 extend beyond the widthwise edges of the channel 14 and the length of the channel 14 is smaller than the length of the gift card 16 such that the type of gift card, the amount of the gift card and/or the printing thereon may be visible while the gift card 16 is inserted in the channel. The channel 14 may have angled upper edges, as shown in FIG. 2, to facilitate the insertion of a gift card 16 into the channel 14. In a preferred embodiment the channel 14 is made of plastic but other materials have been contemplated and are considered to be within the scope of the present invention. The plastic, or other material, may be slightly bendable, also to facilitate the insertion and removal of the gift card 16 from the channel 14. In an alternate embodiment, the two vertical sides 14A, 14B of the channel 14 may also taper outward (from top to bottom) such that the two vertical sides 14A, 14B touch or are very near each other at a top portion thereof and then taper outward toward the bottom of the channel so that the width of the channel increases in size from top to bottom. The channel 14 may be attached to the spring 12 via adhesive, soldering, mechanical attachment mechanism, or any other attachment devices.

Die cut shapes or other adornments may be attached to the outside surface of the two opposing sides of the channel 14 to somewhat conceal the actual channel and also to add a decorative effect to the holder, as described in U.S. patent application Ser. No. 14/664,996, which is incorporated herein by reference in its entirety.

While the channel 14 is able to hold a standard gift card 16 therein without the need for any additional securement mechanisms, the inside surface of the channel 14 may contain one or more protrusions which would help to further secure or compress the gift card within the channel. Also, a gripping material, such as rubber (or any other such material) can be placed on the inside surface of the channel 14 to facilitate gripping the gift card within the channel 14.

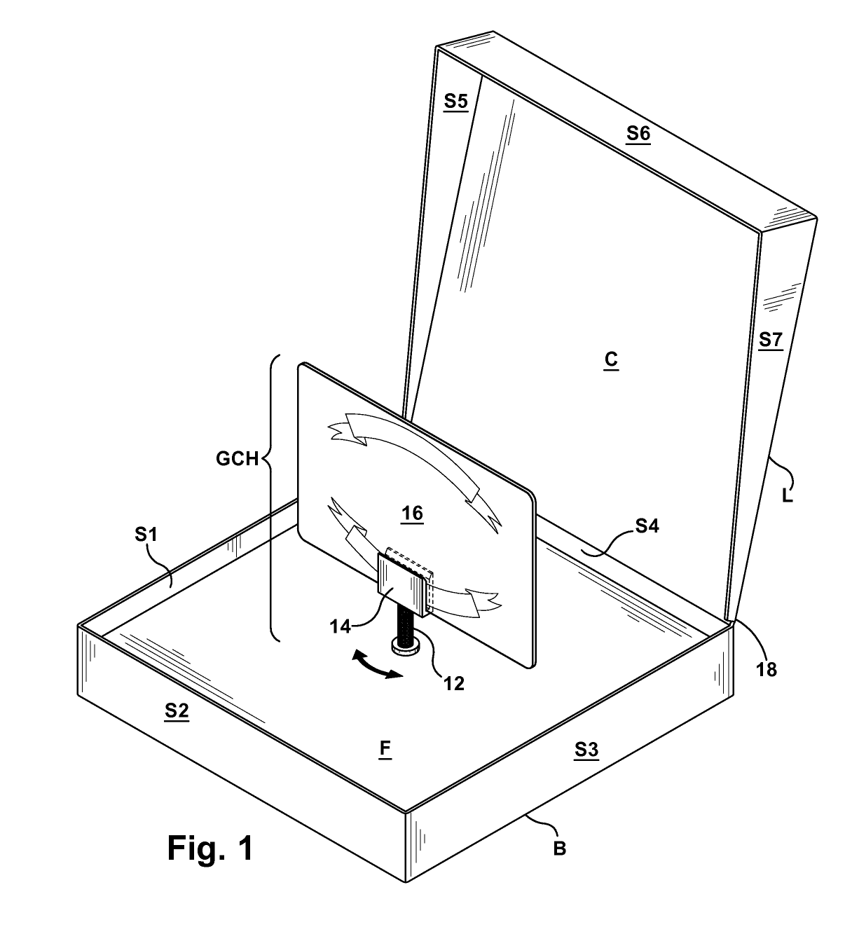

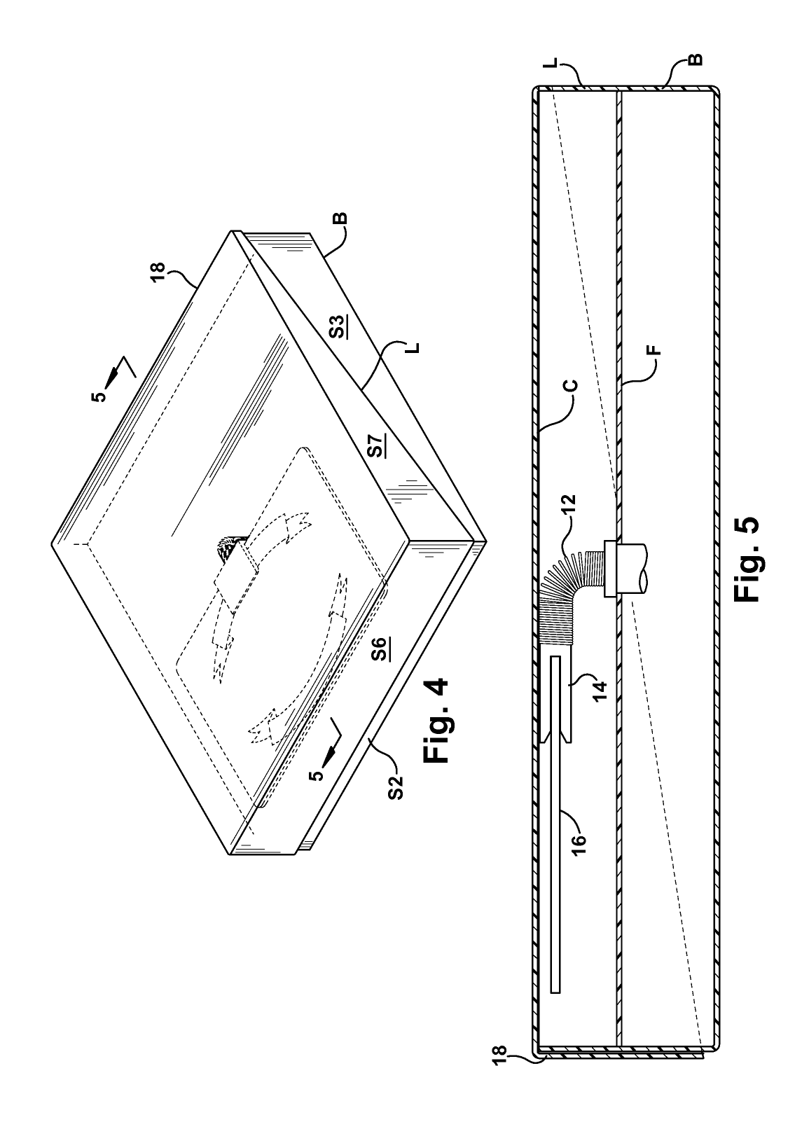

In operation, the spring arm gift card holder GCH of the present invention (along with inserted gift card 16), is placed inside a larger package, such as a box 18, as shown in FIGS. 1, 3 and 4. The box 18 would contain a base portion B, having a floor panel F and side panels S1, S2, S3, S4 which extend upward from each side edge of the floor panel F, and a lid L, which fits over top of the base portion B of the box 18 to create a closed cavity or compartment. The lid L may contain a top or ceiling panel C and side panels S5, S6, S7 which extend downward from each side edge of the top or ceiling panel C. The width of the lid portion L of the box 18 may be slightly larger than the base portion B of the box 18 so that the lid L can fit over the sides S1, S2, S3, S4 of the box 18. The lid L may be completely separated from the base portion B of the box 18 or, as in the preferred embodiment, shown in FIG. 1, it may be attached to the base portion B of the box 18 along one edge forming a hinged opening mechanism. The spring arm gift card holder GCH would be positioned within the box 18 such that at least a portion of the gift card holder GCH is at an elevation above the top edge of the base portion B (or sides thereof S1, S2, S3, S4) of the box 18, as shown in the figures. When the box 18 is in an open position, as shown in FIG. 1, with the lid L removed from the top of the base portion B of the box 18, the gift card holder GCH (and inserted gift card 16) are in a vertical position. When the lid L is placed atop the base portion B of the box 18, to close the box 18, if forces the spring portion 12 of the gift card holder GCH to bend thereby forcing the channel 14 (and inserted gift card 16) into a horizontal or prone position within the box 18, as shown in FIG. 5. The lid portion L of the box 18 must be of such weight that it is able to force the spring 12 into a bended position and to maintain the spring 12 in the bent position while the lid L is covering the base portion B of the box 18 (closed position). When the lid L is removed from the base portion B of the box 18, the spring 12 (along with attached channel 14 and inserted gift card 16) snaps back to its original vertical position, as shown in FIGS. 1 and 3, thereby presenting the user with the gift card 16. Replacing the lid L back onto the base portion B of the box 18 places the spring 12 back into the bent position with the channel 14 and inserted gift card 16 back into the horizontal or prone position until the next time the lid L is removed. The box 18 as shown and described herein is square or rectangular shaped, such as a traditional gift box, however, the box may take on any other shape with any number of sides. The gift card holder GCH of the present invention allows for a surprising and novel way to present a gift card to a recipient.

The end of the spring 12 which is opposite the end which is attached to the channel 14 may be attached to a motor 20 (either directly or indirectly), as shown in FIG. 3, so that the gift card holder GCH may spin or move when the motor 20 is activated (such as, for example, by opening the box 18) or it may be attached to a static portion of the box 18 so that it does not move except to bend and unbend as the box lid L is placed on top of and removed from the base portion B of the box 18.

The foregoing embodiments of the present invention have been presented for the purposes of illustration and description. These descriptions and embodiments are not intended to be exhaustive or to limit the invention to the precise form disclosed, and obviously many modifications and variations are possible in light of the above disclosure. The embodiments were chosen and described in order to best explain the principle of the invention and its practical applications to thereby enable others skilled in the art to best utilize the invention in its various embodiments and with various modifications as are suited to the particular use contemplated. It is intended that the invention be defined by the following claims.

1. A gift card holder comprising:
a spring;
a channel attached to one end of the spring, the channel operative to receive and retain a gift card therein.

2. The gift card holder of claim 1, wherein the channel is u-shaped.

3. The gift card holder of claim 1, wherein at least one die cut shape is attached to an outside surface of the channel.

4. The gift card holder of claim 1, wherein a length of the channel is less than a length of a gift card contained therein.

5. The gift card holder of claim 1, wherein a width of the channel is less that a length of a gift card contained therein.

6. The gift card holder of claim 2, wherein a die cut shape is attached to each vertical side of the u-shaped channel.

7. A gift card holder comprising:
a coiled spring having a first end opposite a second end;
a channel attached to the first or second end of the channel;
wherein the channel is operative to frictionally engage a gift card therein; and
wherein the coiled spring is operative to bend such that it moves the gift card from a vertical position to a horizontal position.

8. The gift card holder of claim 7, wherein the channel has a u-shaped profile.

9. The gift card holder of claim 7, wherein the channel contains angled upper edges.

10. The gift card holder of claim 7, wherein a die cut shape is placed on each vertical side of the channel.

11. The gift card holder of claim 7, wherein a substantial portion of a gift card is visible when it is placed within the channel.

12. The gift card holder of claim 7, wherein the channel has a width which is less than a width of a gift card contained therein.

13. The gift card holder of claim 7, wherein the channel has a length which is less than a width of a gift card contained therein.

14. The gift card holder of claim 7 further comprising a gift card contained within the channel.

15. A gift card holder comprising:
a spring;
a u-shaped channel attached to one end of the spring;
a gift card contained within the u-shaped channel.

16. The gift card holder of claim 15, wherein a length of the gift card is greater than a length of the u-shaped channel.

17. The gift card holder of claim 15, wherein a width of the gift card is greater than a width of the u-shaped channel.

18. The gift card holder of claim 15, wherein a die cut shape is attached to an outer surface of the u-shaped channel.

19. The gift card holder of claim 15, wherein the u-shaped channel contains angled upper edges.

20. The gift card holder of claim 15, wherein the spring is operative to bend such that the u-shaped channel moves from a vertical position to a horizontal position.
